(19) United States
(12) Patent Application Publication
(10) Pub. No.: US 2021/0365550 A1
(43) Pub. Date: Nov. 25, 2021

(54) COMPARING A GENERATED EVENT WITH A RECEIVED RECORD

(71) Applicant: HEWLETT-PACKARD DEVELOPMENT COMPANY, L.P., Spring, TX (US)

(72) Inventors: Adrian John Baldwin, Bristol (GB); Jonathan Griffin, Bristol (GB); Daniel Cameron Ellam, Bristol (GB)

(21) Appl. No.: 16/606,263

(22) PCT Filed: Jun. 7, 2018
(86) PCT No.: PCT/US2018/036460

§ 371 Date: Oct. 18, 2019

(51) Int. Cl. G06F 21/55

(52) U.S. Cl. CPC G06F 21/554; G06F 2221/034

(57) ABSTRACT

In an example, a method includes receiving, at a server device, a record of an event transmitted from a client device which occurred on the client device. At the server device, a record of the event is generated, by a processor. The received record is compared with the record generated at the server device. When at least a portion of the record generated at the server device is not found in the received record, an alert is issued.

### BACKGROUND

Security analytics functions and mechanisms for collecting data to be transmitted to a server may be provided in some systems to monitor and/or protect the operations thereof. In some examples, such data may be transmitted to a remote device for analysis and/or storage.

### BRIEF DESCRIPTION OF DRAWINGS

Examples will now be described, by way of non-limiting example, with reference to the accompanying drawings, in which:

FIG. 1 is a flowchart of an example method;

FIG. 2 is a flowchart of an example method;

FIG. 3 is an example processing apparatus;

FIG. 4 is an example processing apparatus;

FIG. 5 is a simplified schematic representation of an example client-server application; and

FIG. 6 is an example of a machine readable medium in association with a processor.

### DETAILED DESCRIPTION

In some examples herein, data sent to a server device (for example, a cloud device) may be monitored to determine whether the data is of good quality (e.g. has not been tampered with). For example, it may be intended to monitor whether an event within a transmitted data stream, to be transmitted to a server, is missing when the data stream is received by the server. The data may relate to security functions, for example comprising data output by a firewall or virus monitoring service. There can be issues in trusting a client device, for example, trusting whether a client device has not been subverted and is correctly performing checks. For example, malware may hook data or functions, e.g. data or functions comprising an application programming interface (API), resulting in suspicious behaviour not being reported. In addition, the security of transmitted data may itself be compromised. For example, malware may hook and change a function being computed or to be computed.

In some examples set out below, a record of an event is generated by a server which is then compared with a record of an event received at a server (transmitted from a client device). If the comparison results in there not being a match between the received record event and the generated record then this may be indicative of tampering and an alert may be issued. The event may relate to a security threat. In some examples, a security alert on a client device may be deliberately triggered in order to determine if an expected report of the event is correctly generated and fully received at the server. During a ‘normal’ operation, events may be generated and a record of those events may be sent to a server. These events may be acted upon as normal. In some examples set out below, a server generates event records that it is expecting to receive and then compares them to received records in the received event (record) stream. An alert may be generated when, as a result of the comparison, it is found that event records are missing from the received event records.

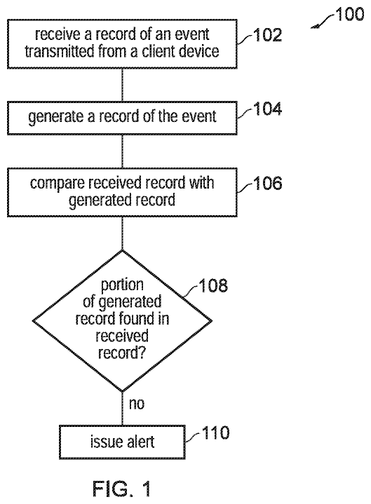

FIG. 1 is an example of a method 100, which may be a computer implemented method, and may be a method of validating a monitoring service of a client device. The method 100 may be carried out using at least one processor.

The method 100 comprises, in block 102, receiving, at a server device, a record of an event transmitted from a client device, wherein the event occurred on a client device. In one example, the record of an event may be part of a normal data stream transmitted from a client device to the server device. In one example, a management agent providing a monitoring service may be running on the client device, e.g. within an operating system on the client device, and the management agent may be to collect and relay data to the server device. In such an example the management agent may be sampling data at predetermined intervals, for example by pulling a log file of event data or pulling configurations to then be transmitted to the server device. Such data may comprise detection events from security systems.

In block 104 the method 100 comprises generating, at the server device, a record of the event. For example, the event may be reproduced, and/or the expected response of a monitoring service such as a management agent on the client device may be generated. In one example the record of the event may be generated so as to be identical to the record that should have been generated and transmitted by, the client device (the expected transmitted record). In another example the generated record of the event may be associated with the expected transmitted record of the event. In another example, the generated record of the event may comprise a portion of the expected transmitted record of the event. In block 104 the server device therefore may generate a record of the event that the server device is “expecting” to receive from the client device. As will be discussed below, the server device may therefore be synchronised, to some degree, with the client device.

In some examples the event, may be selected from a set of available events.

The method 100 comprises, in block 106, comparing the received record with the record generated at the server device. This may allow the method 100 to check if the received record matches the record generated at the server device. In other words, the server device, having generated a record of an event that it “expects” to receive, can compare the generated record with the received record to check whether the server device has actually received what it expected to receive. In block 108, when at least a portion of the record generated at the server device is not found in receive record, then the method 100 comprises, in block 110, issuing an alert.

This effectively allows a check on whether a part of a client-server application has failed. For example, not receiving the expected record at the server device may be an indication that one component in transmitting and receiving the record has failed to adequately perform its function. Not receiving the expected record may also be an indication that it has been hooked by malware, or that malware has acted on the system—for example malware may have turned off any systems designed to detect an attack. This may also be a (more general) indication that systems designed to detect an attack have been turned off (for example, by malware, but also they may have been turned off advertently or inadvertently—by a user).

As noted above, in some examples, the event may be triggered deliberately to provoke a response. In order to assess whether malware or the user has interfered with the transmitted record, the event may be designed to specifically target a certain type of malware. In such examples, the record of an event occurring on, and being transmitted by, the client device may be associated with a malicious action. For example, the event may comprise data, or instructions, vulnerable to an attack by malware. In this example, method 100 may be a method of checking if a client device's security functions are properly working. According to this example, a record of an event is transmitted to the server device, which independently generates a record of the same event. The server therefore expects to receive a record that matches the record that it generated. In block 108, if at least part of the generated record is not found in the received records then that may be an indication that malware has intervened. In another example, not receiving the expected record (or not receiving it in full), even in examples where the event is associated with a malicious action, may also be an indication of the malfunction of at least one component/device involved in the transmission.

As will be discussed below, the event may for example comprise at least one of: instructions to download a file, download a file with a known anti-virus signature, instructions to create a file, instructions to run malware or malware like code without the harmful actions, instructions to run blacklisted code or non-whitelisted code, instructions to call API sequences often associated with malware, instructions to run malware like command and control or exfiltration network activity, instructions to send a file to a known location, instructions to update a signature list, instructions to update a root certificate list, instructions to install a new piece of software, instructions to disable or change at least one security checking function; instructions to disable or change at least one security setting.

Accordingly, in one example, the method 100 generates a benign record of an event that will look like an attack. In this way, the method 100 can check if the security functions of a client-server application are working correctly. As the method 100 creates an alert when a record of this type of faux-malicious event is not received (or does not have the expected content) this allows an operator to intervene to correct any deficiency in the system's security functions so that, when a real malicious event is transmitted, they may work correctly.

When the server identifies the generated record and the received record sufficiently corresponds, this indicates that the monitoring service of the client device has functioned appropriately, and that transmission has occurred without error. The alert issued when this is not the case suggests to a user that there is something wrong with the normal functioning of the system.

For example, some systems use black and white lists to enforce certain behaviours. An event associated with a malicious action may be related to a blacklisted and/or non-whitelisted function. In another example, malware may attempt to change a root certificate list or an AV signature. In such an example the event may be related to changing the root certificate list in order to test whether this kind of vulnerability is properly ensured against. Such an event may result in the malware changing a root certificate list which in turn may mean that a received record may be associated with checking code scanning the root certificate store and noticing additional entries. Therefore, in this example, the alert flags to an operator that this type of malware has subverted a security check. According to another example, malware may use DLL injection. In this example a record of an event may contain a sequence of APIs that use DLL injection so that the transmission of such a record is vulnerable to the removal of checks from an AV system or the hooking or reporting APIs so that certain events do not get reported. The event may be ‘benign’ in that, even if the record is hooked by malware, it does not affect the wider operation of the system.

In one example the server device may trigger the event the record of which is to be transmitted by the client device, and create a response in the form of generating a record of the event. In this way the server device may both trigger the event and create a response. This may comprise retrieving the event from a memory to generate the record.

As will be discussed below, an event may be triggered by generating an action, or generating and running an action. For example, the event may comprise running an action, wherein running the action generates the event, or the record of the event. An “action” may comprise a set of scripts, or code, to be run, or an executable function, or an internal module function etc. that when run, or executed, results in the record of the event. As discussed above, an action may be associated with a malicious action, and/or a malicious event, such that generating the action causes the generation of a record of an event associated with a malicious action.

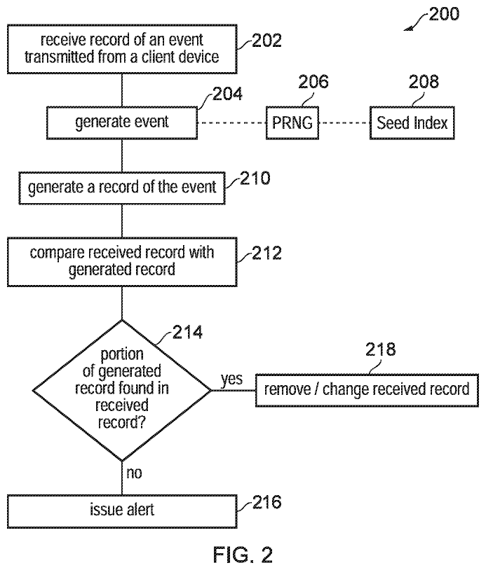

FIG. 2 is an example of a method 200, which may be a computer implemented method.

Block 202 comprises receiving, at a server device, a record of an event transmitted from a client device, where the event occurred on a client device.

In block 204, the method 200 comprises generating an event which is expected to trigger a corresponding record associated with the record of the event transmitted from the client device. Generating an event, in block 204, comprises, in blocks 206 and 208 respectively, generating an event based on the output of a pseudo-random number generator based on a seed index, which may be a random seed index. Specifically, in block 208, a seed index is chosen and, in block 206, used as an input to a pseudo-random number generator. The seed index may be user-selectable or automatically determined. The output of the pseudo-random number generator, at block 206, may be used to determine which event is generated in block 204, In some examples the event, generated at block 204, may be selected from a set of available events, each event in the set corresponding to a record of an event.

In some examples, generating an event based on the output of a pseudo-random number generator based on a seed index, which may be a random seed index, and the random seed index is shared between the client device and the server device. For example, a table which, for a given server, given an index into a seed table is able to retrieve the seed index for a particular client device. Different client devices may therefore have their own seeds, and the server device may, via a look-up table or the like, retrieve the seeds for specific client devices. A formula may also be used (for example the seed for a particular device x may be equal to hash(seed+device x serial number)). The server device may, for a given device, have and use the same seed index to produce a synchronous record of the same event.

In block 210 a record of the event is generated, based on the event generated in block 204. In some examples generating the event generates the record of the event. In other examples the event generated may need to be run (i.e. executed) in order to generate the event. In another example, generating the event may comprise generating an action corresponding to that event.

The method 200 comprises, in block 212, comparing the received record with the record generated at the server device. This may comprise a deterministic selection process in which the server is synchronised with the client device and therefore is able to generate a record of the same event. For example, the client device and the server device may each comprise a pseudo-random number generator, and the client and serves devices may input the same seed into their respective pseudo-random number generators to generate the same events. When, at block 214, at least a portion of the record generated at the server device is not found in the received record, the method 200 comprises, at block 216, issuing an alert. When, at block 214, at least a portion of the record generated at the server device is found in the received record, the method 200 may comprise, at block 218, altering or removing the received event. For example, block 218 may comprise removing the received event from a data, or event, stream transmitted to the server device from the client device. In this way, there may be an stream of records of events received at the server representing events that would normally (i.e. without interference) occur. In addition to these ‘normal events’, a record of an event associated with an added malicious action may be added to the stream of received records of events. Such a stream may normally be processed by the server upstream where events are examined to see whether they indicate that malicious activity is occurring on the client device. If records of events were left in the stream then they may be processed downstream to suggest that a malicious action has occurred—but by removing the received record at block 218 this may be prevented. For example, when the record of an event associated with a malicious action is a fake or faux “bad action”, i.e. one generated at the client device with the intention of checking the security functions, removing the record at block 218 may avoid the server indicating that there has been a security breach (which may not have occurred given that the malicious event may have been artificially created), If the events generated at the client device are not received this may suggest that the systems being used to generate the events are not working correctly, or wrong, and hence an alert may be issued.

At block 216, issuing an alert may comprise collecting and presenting statistics associated with the received record. The statistics may comprise information concerning the details of the record of the event transmitted. For example, the collected statistics may comprise information regarding where the record of the event was generated and transmitted from. If part of the generated record was not found in the received record then this may indicate that part of the system is not functioning correctly. The statistics may comprise statistics concerning monitoring information and information relating to a device's power cycle.

At block 216, issuing an alert may comprise tagging the received record of the event with additional information. The additional information may comprise details of the differences between the received record and the generated record. For example, if an individual entry was removed then the additional information may comprise details concerning the removed entry. At block 216, further analytics may be performed.

At block 216, an alert may therefore be issued when a portion of the event record information that the server is expecting to be there was not contained with the received record from the client device. This alert may comprise at least one of: the event that generated the event record information at the server, and any event records that partially meet the expectations of what should be in the event stream. Block 216 may comprise sending this information to a human operator (or an automated diagnostic module) so that it may be determined what is not working (i.e. which actions are not leading to event records, and hence why an issue may be present). Further investigation and/or corrective action may then be taken. A number of times an issue, or issues, are occurring on a given client device may also be recorded and alerted to an operator.

In one example, the record of the event generated at block 210 may be synchronised with a generation of the record of the event to be transmitted by the client device. In one example, the event generated at block 204 may be synchronised with a generation of an event associated with the transmitted record of the event, at the client device. Accordingly, the method 200 may be utilised in a client-server application where the client device and server device are synchronised.

The event may comprise at least one of: instructions to download a file or instructions to create a file (e.g. with a signature that triggers an AV system); instructions similar to those in malware (including looking for evidence of ‘sandboxing’, actions that look like DLL injection, inserting hidden registry entries that look like malware (e.g. in hiding), adding hooks to an API system, changing privileges); instructions to run blacklisted code or non-whitelisted code; instructions to update a signature list (e.g. an AV signature list); instructions to update a root certificate list; instructions to install a new piece of software; instructions to disable or change at least one security checking function; instructions to disable or change at least one security setting (such as security sensitive settings, e.g. stopping AV, disabling volume shadow copy); and running malware like communications (such as DGAs, beaconing, or strange network protocols).

In some examples, a set of data including the record of an event may be transmitted to the server device. In some examples the record of an event may be one of a plurality of a record of events. At least one event may be associated with a malicious action. The server may generate a plurality of records, each associated with a transmitted record of an event. At the server, generated records may be associated with observations, and comparing, at block 212, may comprise comparing the observations to the received record of the event.

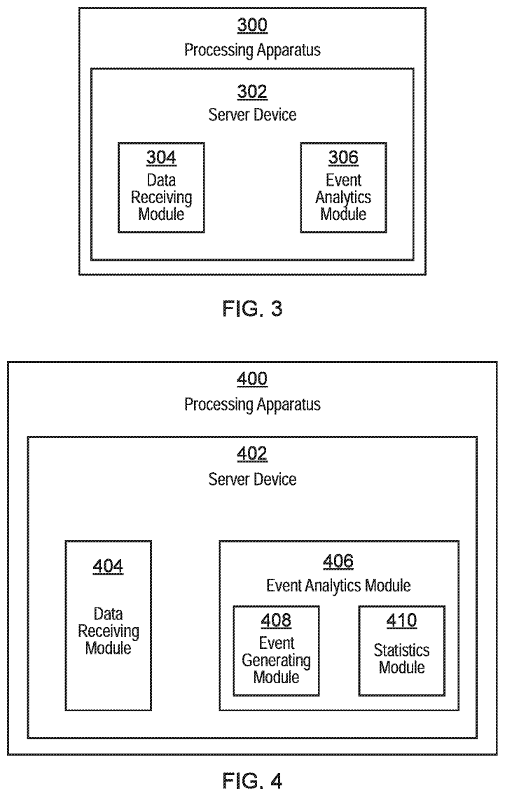

FIG. 3 is an example of a processing apparatus 300 having a server device 302. The server device 302 comprises a data receiving module 304 and an event analytics module 306. The data receiving module 302 is to receive a record of an event which occurred on, and was transmitted from, a client device. The event analytics module 304 is to generate data corresponding to the event which occurred on the client device, and to compare the generated data with the record received by the data receiving module. This may be predetermined, or may be generated by deploying the event on the server. The event analytics module 304 is further to issue an alert if at least a portion of the generated data is not found in the record received by the data receiving module 302.

The processing apparatus 300 of the example of FIG. 3 may perform any of the methods 100 or 200 as set out in FIG. 1 or 2, respectively,

FIG. 4 is an example of a processing apparatus 400 having a server device 402. The server device 402 comprises a data receiving module 404 and an event analytics module 406, The data receiving module 402 is to receive a record of an event which occurred on, and was transmitted from, a client device. The event analytics module 406 is to generate data corresponding to the event which occurred on the client device, and to compare the generated data with the record received by the data receiving module, and to issue an alert if at least a portion of the generated data is not found in the record received by the data receiving module 402. The event analytics module 406 comprises an event generating module 408 to generate an event, wherein generating data corresponding to the event which occurred on the client device comprises generating an event at the event generating module 408, and then generating data corresponding to the event generated at event generating module 408. The event analytics module 406 also comprises a statistics module 410 to generate statistics associated with the received record. The event generating module 408 may be synchronised with a client device.

In one example the statistics may comprise information concerning the details of the record of the event transmitted. For example, the collected statistics may comprise information regarding where the record of the event was generated and transmitted from. If part of the generated record was not found in the received record then this may indicate that part of the system is not functioning correctly. The statistics may comprise statistics concerning monitoring information and information relating to a device's power cycle. The statistics may comprise observations concerning the received record and any comparison made by the event analytics module 406 may utilise statistics from the module 410. For example generated records may be associated with observations, and any comparison, by the analytics module 406, may comprise a comparison of the observations to the received record of the event. Power cycle information may be used to determine if given records should be missing, for example because the client device is switched off, or to determine additional timing information as to when to expect a received event if timings are based on uptime.

The processing apparatus 400 of the example of FIG. 4 may perform any of the methods 100 or 200 as set out in FIG. 1 or 2, respectively.

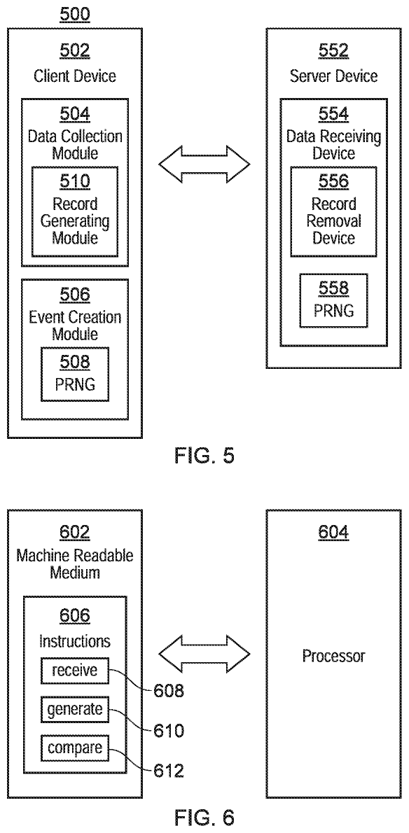

FIG. 5 is an example client-server application 500 comprising a client device 502 in communication with a server device 552.

The client device 502 comprises a data collection module 504 to collect and relay data to the server device 552. For example the data collection module 504 may sample data at certain points, e.g. concerning the operation of a particular function of an operating system, and relay this to the server device 552. In some example, the data collection module 504 is monitoring service of the client device 502. The data collection module 504 may perform security detections on any data that it collects, for example comprising a firewall, a virus scanner or the like.

The client device 502 comprises an event generation module 506 to generate an event which may in turn result in a record of an event which the data collection module 504 may transmit to the server device 552, e.g. as part of a normal routine data collection and transmission operation. For example an event may comprise a set of scripts to be run, or code to be executed. The client device 502 comprises a record generation module 510 to generate a record of the event.

The client device 502 may comprise a pseudo-random number generator (PRNG) 508 operatively associated with the event generation module 506. A seed may be used as an input into the PRNG 508 which may then output a particular event, which may be from a set of events, to be generated by the event generation module 506. The event generation module 506 may comprise a scheduler which may be to decide when the event generation module 506 is run, i.e. when an event should be generated, and which of the set of available events is to be run. The scheduler may therefore be operatively associated with the PRNG 508. Malware may become aware of records of (different) events being generated at regular periodic intervals, or to random generations of the same record of an event, which makes such records vulnerable to spoofing. Therefore, the scheduler may be to randomly generation of events, and records of events, at random times. In this way, a client-server application may become less predictable to malware.

The server device 552 comprises a data receiving system 554 to receive data transmitted from the client device 502. The server device 552 comprises a PRNG 558 which may be synchronised with PRNG 508 of the client device 502. PRNG 558 may utilise the same seed that is used as an input to the PRNG 508. In this way, both the client device 502 and the server device 552 may generate the same event, resulting in the same record of the event, e.g. the same record of the same event, at the same time. In this way, the server 552 is able to generate an expected record that, provided no malicious interventions have occurred, it should receive from the client device 502.

In some examples, the output of the or each pseudo-random number generator may be based on a seed index, which may be a random seed index, and the random seed index is shared between the client device and the server device. For example, the server device 522 may comprise a table which, given an index into a seed table is able to retrieve the seed index for the client device 502. A formula may also be used (for example the seed for a particular device x may be equal to hash(seed+device x serial number)). The server device 552 may, for a given client device 502, have and use the same seed index to produce a synchronous record of the same event.

The server device 552 comprises a record removal module 556 to compare the received record from the client device 502 with the generated record from the data receiving system 554. The record removal module 556 is to issue an alert when at least a portion of the record generated at the server device is not found in the received record, and, when at last of the portion of the record generated at the server device is found in the received record, to change or remove the record of the event. The latter instance may be an indication that there has not been any tampering of the record during transmission from the client device 502.

The event generated by the module 506 may be a benign, or fake, event associated with a malicious event. In this way, the client device 502 and server device 552 may, in synchronisation, generate benign events that appear malicious so as to test a monitoring function of the client device. For example, when an expected record is not received by the server device 552 (for example if detection software has been manipulated or deactivated by malware), this may be detected in a safe manner such that the functioning of the client-sewer apparatus 500 is not adversely affected (as it may be if the bad event was genuinely malicious).

The processing apparatus 500 of the example of FIG. 5 may perform any of the methods 100 or 200 as set out in FIG. 1 or 2, respectively.

FIG. 6 is an example of tangible (and non-transitory) machine readable medium 602 in association with a processor 604. The tangible machine readable medium 602 comprises instructions 606 which, when executed by the processor 604, cause the processor 604 to carry out a plurality of tasks. The instructions 606 comprise instructions 608 to cause the processor 604 to receive a record of an event associated with a malicious action. The instructions 606 comprise instructions 610 to generate data corresponding to the event. The instructions 606 comprise instructions 612 to compare the generated data with the receive record and issue an alert if at least a portion of the generated data is not found in the received record.

The machine readable medium 602 of the example of FIG. 6 may comprise instructions to perform any, or a combination, of the blocks of methods 100 or 200 as set out in FIG. 1 or 2, respectively; and/or to provide the event analytics modules 306 or 406 of the examples of FIGS. 3 and 4, respectively; and/or to provide the data receiving module 554 of the action removal module 556 of the example of FIG. 5.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
receiving, at a server device, a record of an event transmitted from a client device, wherein the event occurred on a client device;
generating, at the server device, by a processor, a record of the event;
comparing the received record with the record generated at the server device; and, when at least a portion of the record generated at the server device is not found in the received record, issuing an alert.

2. A method as claimed in claim 1 comprising triggering the event at the client device, wherein the event is associated with a malicious action.

3. A method as claimed in claim 1 wherein generating, at the server device, the record of the event comprises generating an event, wherein generating the event results in the generation of the record of the event.

4. A method as claimed in claim 3 wherein generating an event comprises inputting a seed into a pseudo-random number generator, and wherein the output of the pseudo-random number generator corresponds the event to be generated.

5. A method as claimed in claim 1 wherein comparing the received record with the record generated at the server device comprises, when at least a portion of the record generated at the server device is found in the received record, removing the received record or changing at least part of the received record.

6. A method as claimed in claim 1 wherein issuing an alert comprises collecting statistics associated with the received record.

7. A method as claimed in claim 1 wherein the event comprises at least one of: downloading a file, creating a file, running malware (or malware like behaviours), running blacklisted code or non-whitelisted code, updating a signature list, updating a root certificate list, installing a new piece of software, disabling or changing at least one security checking function; disabling or change at least one security setting.

8. A method as claimed in claim 1 wherein issuing the alert comprises tagging the received record with additional information associated with the received record.

9. Processing apparatus comprising:
a server device comprising:
a data receiving module to receive a record of an event which occurred on, and was transmitted from, a client device; and
an event analytics module to generate data corresponding to the event which occurred on the client device, and to compare the generated data with the record received by the data receiving module, and to issue an alert if at least a portion of the generated data is not found in the record received by the data receiving module.

10. Processing apparatus as claimed in claim 9 wherein the event is associated with a malicious action.

11. Processing apparatus as claimed in claim 10 wherein the event comprises at least one of: downloading a file, creating a file, running malware, running blacklisted code or non-whitelisted code, updating a signature list, updating a root certificate list, installing a new piece of software, disabling or changing at least one security checking function; disabling or change at least one security setting.

12. Processing apparatus as claimed in claim 9 wherein the event analytics module comprises:
an event generating module to generate an event,
wherein generating data corresponding to the event which occurred on the client device comprises generating an event at the event generating module.

13. Processing apparatus as claimed in claim 9 wherein the event analytics module comprises:
a statistics module to generate statistics associated with the received record.

14. A non-transitory machine-readable storage medium, encoded with instructions executable by a processor, the machine-readable storage medium comprising instructions to cause the processor to:
receive a record of an event associated with a malicious action;
generate data corresponding to the event; and
compare the generated data with the received record and issue an alert if at least a portion of the generated data is not found in the received record.

15. A non-transitory machine-readable storage medium as claimed in claim 14, wherein the event comprises at least one of: downloading a file, creating a file, running malware, running blacklisted code or non-whitelisted code, updating a signature list, updating a root certificate list, installing a new piece of software, disabling or changing at least one security checking function; disabling or change at least one security setting.
